(19) United States
(12) Patent Application Publication
(10) Pub. No.: US 2018/0336029 A1
(43) Pub. Date: Nov. 22, 2018

(54) ARITHMETIC PROCESSING DEVICE AND CONTROL METHOD FOR ARITHMETIC PROCESSING DEVICE

(71) Applicant: FUJITSU LIMITED, Kawasaki-shi (JP)

(72) Inventor: Takashi Ichimura, Kawasaki (JP)

(73) Assignee: FUJITSU LIMITED, Kawasaki-shi (JP)

(21) Appl. No.: 15/980,784

(22) Filed: May 16, 2018

(30) Foreign Application Priority Data
May 19, 2017 (JP) 2017-099694

(51) Int. Cl. G06F 9/30; G06F 12/0875

(52) U.S. Cl. CPC G06F 9/3001; G06F 2212/452; G06F 12/0875; G06F 9/30043

(57) ABSTRACT

An arithmetic processing device includes a plurality of processing units, each having a core, a memory, and a memory access controller (a MAC hereafter) that controls access to the memory in response to an access request issued by the core. The core of a first processing unit executes a store instruction to issue a store request for the store instruction, and the MAC of the first processing unit, in response to the store request issued by the core of the first processing unit, when the store request requests an inter-unit copy, which stores data to the memory of a second processing unit, issues a write request of an intra-unit store, which stores the data to the memory of the first processing unit, to the memory of the first processing unit, and transmits a request of the inter-unit copy to the MAC of the second processing unit.

### CROSS-REFERENCE TO RELATED APPLICATION

This application is based upon and claims the benefit of priority of the prior Japanese Patent Application No. 2017-099694, filed on May 19, 2017, the entire contents of which are incorporated herein by reference.

### FIELD

The invention relates to an arithmetic processing device and a control method for the arithmetic processing device.

### BACKGROUND

An arithmetic processing device is a semiconductor chip having a plurality of processing units, each processing unit having a core that includes an arithmetic unit, and a cache memory, for example. Further, in an on-chip distributed memory type arithmetic processing device, each of the plurality of processing units is provided with a core, a cache memory, and a memory belonging to the core.

In an on-chip distributed memory type arithmetic processing device, the core in each processing unit performs various types of arithmetic processing at high speed by accessing the memory provided in the processing unit. Further, data in the memory of the processing unit are transferred by inter-unit transfer to another processing unit by a direct memory access controller (a DMAC) provided in the processing unit. For this purpose, the core outputs a DMA transfer request requesting transfer between the memory of the other processing unit and the memory of the host processing unit to the DMAC, whereupon, by the DMAC, either data in the memory of the other processing unit are transferred to the memory of the host processing unit, or data in the memory of the host processing unit are transferred to the memory of the other processing unit. Thus, the core executes load or store indirectly to or from the memory of the other processing unit.

Japanese Laid-open Patent Publication No. H10-276198, Japanese Laid-open Patent Publication No. H07-200506, and Japanese Laid-open Patent Publication No. 2000-330928 describe on-chip distributed memory type arithmetic processing devices.

### SUMMARY

In an on-chip distributed memory type arithmetic processing device, a case, in which a certain processing unit executes first processing to output a first processing result and then a plurality of processing units execute second processing in parallel with respect to the first processing result, is considered. In this case, the processing unit that executes the first processing stores a processing result in the memory thereof and transfers data from the memory thereof to the memories of the other processing units every time a predetermined processing step of the first processing is completed. In so doing, the plurality of processing units can start the second processing quickly following completion of the first processing.

During the first processing, however, the processing unit that executes the first processing executes both storing in the memory thereof and data transferring to the memories of the other processing units every time the predetermined processing step is completed. In other words, the processing unit executes a store instruction and a data transfer instruction repeatedly a plurality of times, leading to an increase in the time needed for the processing unit to execute the first processing.

According to an aspect of the present embodiment, an arithmetic processing device includes: a plurality of processing units, each having a core that executes arithmetic processing, a memory, and a memory access controller (a MAC hereafter) that controls access to the memory in response to an access request issued by the core. The core of a first processing unit among the plurality of processing units executes a store instruction to issue a store request for the store instruction, and the MAC of at least the first processing unit: in response to the store request issued by the core of the first processing unit, when the store request requests an inter-unit copy, which stores data of the store request to the memory of a second processing unit different from the first processing unit, issues a write request of an intra-unit store, which stores the data of the store request to the memory of the first processing unit, to the memory of the first processing unit, and transmits a request of the inter-unit copy to the MAC of the second processing unit.

According to the embodiment described above, the arithmetic processing unit executes storing in the memory of a host processing unit and storing in the memory of another processing unit efficiently.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example configuration of a certain arithmetic processing device.

FIG. 2 is a diagram illustrating an example configuration of the arithmetic processing device according to this embodiment.

FIG. 3 is a diagram illustrating processing executed by the arithmetic processing device according to this embodiment.

FIG. 4 is a diagram illustrating a configuration of one processing unit and data transmitted in response to a store instruction, according to the first embodiment.

FIG. 5 is a diagram illustrating an operation sequence of the store instruction according to the first embodiment.

FIG. 6 is a diagram illustrating an example configuration of the address calculation circuit.

FIG. 7 is a diagram illustrating the calculations performed by the address calculation circuit.

FIG. 8 is a flowchart illustrating an operation of the copy control circuit COPY_CN.

FIG. 9 is a diagram illustrating a configuration of the MAC circuit MAC_CR.

FIG. 10 is a diagram illustrating a configuration of one processing unit and data transmitted in response to a store instruction, according to the second embodiment.

FIG. 11 is a diagram illustrating an operation sequence of the store instruction according to the second embodiment.

FIG. 12 is a flowchart illustrating operations relating to the store instruction, according to the second embodiment.

FIG. 13 is a diagram illustrating an example configuration of the address calculation circuit.

FIG. 14 is a diagram illustrating a configuration of one processing unit and data transmitted in response to a store instruction, according to the third embodiment.

FIG. 15 is a diagram illustrating an operation sequence of the store instruction according to the third embodiment.

FIG. 16 is a flowchart illustrating operations performed in response to the store instruction, according to the third embodiment.

FIG. 17 is a diagram illustrating an example configuration of the copy determination circuit.

FIG. 18 is a diagram illustrating a configuration and an operation of a certain processing unit according to the fourth embodiment.

### DESCRIPTION OF EMBODIMENTS

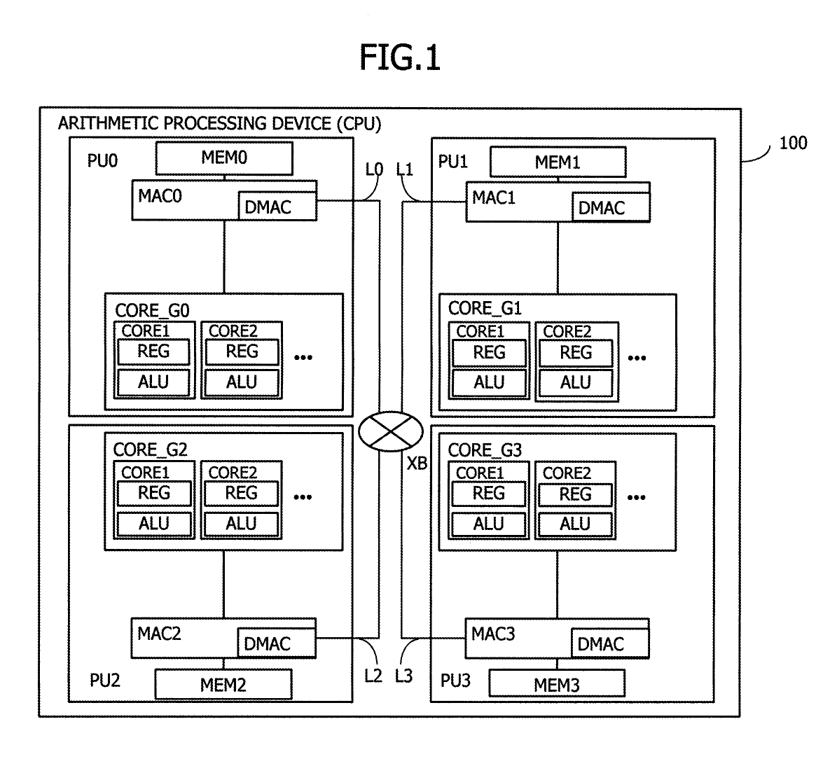

FIG. 1 is a diagram illustrating an example configuration of a certain arithmetic processing device. An arithmetic processing device 100 constituted by a central processing unit (CPU) chip or a processor includes a plurality of (four, for example) processing units PU0-PU3, as well as inter-unit wires L0-L3 and a cross bar switch XB connecting the processing units to each other. The cross bar switch XB is capable of transferring requests and data between the processing units by connecting the inter-unit wires L0-L3 to each other on the basis of control signals from the respective processing units.

The processing units PU0-PU3 respectively include core groups CORE_G0-CORE_G3 for executing arithmetic processing, memories MEMO-MEM3, and memory access controllers MAC0-MAC3 for controlling access to a corresponding memory MEM# in response to an access request issued by a core CORE# within the core group.

The core group CORE_G# includes a plurality of cores CORE#, and each core CORE# includes an arithmetic logic unit (ALU) and a register group REG for storing arithmetic subject data and arithmetic result data. Each core CORE# decodes an instruction and causes the arithmetic logic unit ALU to execute arithmetic processing corresponding to the instruction. The register group REG is provided with a load/store unit (not illustrated) for issuing store requests to store data held in the register in the memory and load requests to load data stored in the memory to the register.

Further, MAC0-MAC3 each include a direct memory access controller (a DMAC) that executes data transfer between the memory of a host processing unit and the memories of the other processing units in response to a data transfer request issued by the core.

When the data transfer request issued by the core is a request to transfer data from the memory of the host processing unit to the memories of the other processing units, the DMAC issues a request to the memory of the host processing unit to read the data, and issues a request to the MACs of the other processing units to store the data (the data read from the memory of the host processing unit) in the memories thereof. When, on the other hand, the data transfer request is a request to transfer data from the memory of another processing unit to the memory of the host processing unit, the DMAC issues a request to the MAC of the other processing unit to load the data from the memory thereof, and issues a request to the memory of the host processing unit to write the data (the data loaded from the other processing unit).

With the arithmetic processing device of FIG. 1, in a case where the core CORE# of the processing unit PU0, for example, stores an arithmetic result stored in a result register of the register group REG in the memory MEMO of the host processing unit PU0 and the memories MEM1-MEM3 of the other processing units PU1-PU3, the core CORE# of the processing unit PU0 executes a store instruction and a data transfer instruction. Therefore, to store an arithmetic result in the memory of the host processing unit and the memories of the other processing units, the core executes both a store instruction and a data transfer instruction, leading to a reduction in processing efficiency.

### Embodiment

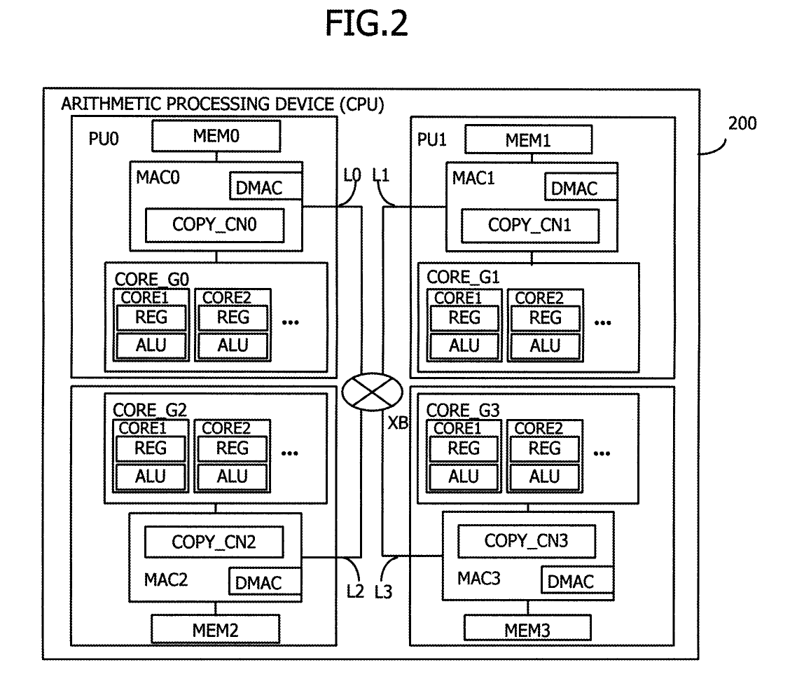

FIG. 2 is a diagram illustrating an example configuration of the arithmetic processing device according to the present embodiment. Similarly to FIG. 1, an arithmetic processing device 200, which is a CPU chip includes a plurality of (four, for example) processing units PU0-PU3, as well as inter-unit wires L0-L3 and a cross bar switch XB connecting the processing units to each other.

The processing units PU0-PU3 respectively include core groups CORE_G0-CORE_G3 for executing arithmetic processing, memories MEM0-MEM3, and memory access controllers MAC0-MAC3 for controlling access to a corresponding memory MEM# in response to an access request issued by a core CORE# within the core group.

The core group CORE_G# includes a plurality of cores CORE#, and each core CORE# includes, in addition to an instruction decoder, not depicted in the figure, an arithmetic logic unit ALU and a register group REG for storing arithmetic subject data and arithmetic result data. Each core CORE# decodes an instruction and causes the arithmetic logic unit ALU to execute arithmetic processing corresponding to the instruction. The register group REG is provided with a load/store unit (not illustrated) for issuing store requests to store data held in the register in the memory, and load requests to load data stored in the memory to the register.

MAC0-MAC3 each include a direct memory access controller (a DMAC) that executes data transfer between the memory of the host processing unit and the memories of the other processing units in response to a data transfer request issued by the core.

In this embodiment, when a store instruction executed by the core CORE# requires inter-unit copying to the memory of the other processing unit that is different from the host processing unit, by the single store instruction, the MAC# issues a write request for an intra-unit store to the memory of the host processing unit, and transmits an inter-unit copy request to the MAC of the other processing unit over the inter-unit wires. Accordingly, the MAC of the other processing unit issues a request to the memory thereof to execute writing in response to the inter-unit copy request.

Further, when the store instruction does not require inter-unit copying, the MAC# issues the write request for the intra-unit store to the memory of the host processing unit and does not issue the inter-unit copy request.

In other words, in this embodiment, each core is capable of executing a first store instruction for implementing intra-unit store alone, and a second store instruction for implementing inter-unit copy in addition to intra-unit store, by means of a single store instruction. By executing the second store instruction, in addition to an intra-unit copy, an inter-unit copy request can be issued to one or a plurality of other processing units, and the other processing units that are to serve as copy destinations can be specified as desired. Furthermore, to determine whether a store instruction is the first store instruction or the second store instruction, a set value of the store instruction is able to be set in an operand of the store instruction as a parameter, or set in the register in advance.

Here, the inter-unit copy request is a request to store data held in the register in the host processing unit in the memory of a different processing unit from the host processing unit. To distinguish the inter-unit copy request from the intra-unit store request, the word “copy” has been attached thereto, giving the name “inter-unit copy request”. In other words, storing to the memory of the host processing unit will be referred to as intra-unit store, and storing to the memory of another processing unit will be referred to as inter-unit copying.

In this embodiment, each MAC# includes a copy control circuit COPY_CN0-COPY_CN3 for distinguishing a second store instruction including an inter-unit copy request from a first store instruction not including an inter-unit copy request, and generating a copy destination memory address to enable the inter-unit copy request.

A store instruction is typically an instruction to write data held within a certain register address range to a certain memory address range in the memory. Accordingly, a store source register address range and a store destination memory address range are specified in the store instruction. Normally, a store source top register address, a data length, and a store destination top memory address are provided. The copy control circuit generates a store destination memory address specified by the intra-unit store request and a copy destination memory address specified by the inter-unit copy request on the basis of the store destination memory address range specified by the store instruction.

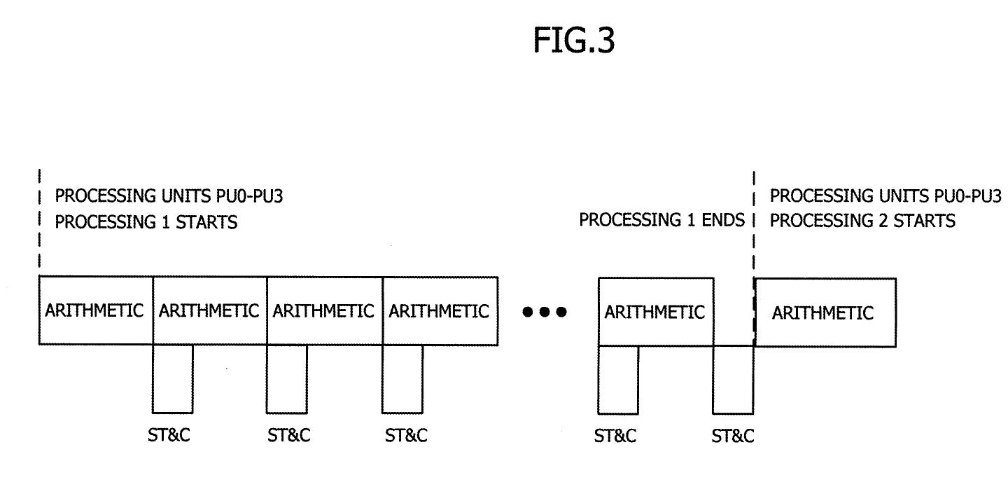

FIG. 3 is a diagram illustrating processing executed by the arithmetic processing device according to this embodiment. In the arithmetic processing device 200, when the cores of the respective processing units execute subsequent processing using arithmetic results generated by the other processing units, the cores executing the arithmetic execute the second store instruction requesting inter-unit copying. After the second store instruction is executed, the arithmetic results are stored in the memory of the host processing unit and the memories of the other processing units simultaneously.

In FIG. 3, a horizontal direction corresponds to a time axis, and processing 1 and processing 2 are executed as described below.

In processing 1, the processing 1 is apportioned or shared to the respective processing units PU0-PU3 so that each processing unit executes different processing.

In processing 2, the respective processing units execute the processing 2 using arithmetic results generated by the respective processing units in processing 1.

The process in which processing 1 and 2 is executed is as follows.
1.The cores of the respective processing units PU0-PU3 load arithmetic subject data from the respective memories MEM0-MEM3 thereof to the registers REG.
2. The cores of the respective processing units start processing 1.
3.When the core of each processing unit completes a certain step of arithmetic, the core stores the arithmetic result in the memory of the host processing unit from the register, and simultaneously stores (copies) the arithmetic result in the memories of the other processing units (ST&C). While storing and copying ST&C is underway in this manner, subsequent arithmetic is executed. The cores realize the storing and copying ST&C by executing the second store instruction.
4.The cores of the respective processing units repeat the processing of section 3 until processing 1 is complete.
5.When processing 1 is complete, the cores of the respective processing units execute subsequent processing 2 using the arithmetic results of processing 1.

Hence, in the processing of section 3, instead of waiting until all of the arithmetic of processing 1 is complete, the arithmetic results are stored (copied) in the memory of the host processing unit and the memories of the other processing units, and therefore the cores of the respective processing units can start processing 2 earlier than a cache where the arithmetic results are stored in the memories after all of the arithmetic of processing 1 is complete.

In this embodiment, the cores of the respective processing units can store an arithmetic result held in the register in the memory of the host processing unit (intra-unit store) and the memories of the other processing units (inter-unit copying) by executing a single store instruction (the second store instruction) that includes inter-unit copying. In processing 1, therefore, the storing and copying processing executed every time a certain step of arithmetic is completed is executed by means of a single store instruction, and as a result, the time needed by the cores to execute processing 1 from start to finish can be shortened.

Store Instruction
Novel improvements described below are added to realize the store instruction described above.

Firstly, a store instruction can request copying the store data to the memories of the other processing units. In this store instruction, a copy bit indicating whether or not inter-unit copying is needed and copy destination processing unit information are added as parameters in addition to the store source register address and store destination memory address needed in a normal store instruction. By setting the copy bit in the inter-unit copy request and specifying the processing units to which copying is to be performed in the copy destination processing unit information, data held in the register can be stored (copied) in the memories of desired processing units as well as the memory of the host processing unit by executing a single store instruction.

Secondly, when storing data in a plurality of store source registers, the store source top register address, store destination top memory address, and data length are set as the parameters of the store instruction instead of the store source register address and the store destination memory address. When the store instruction is executed in this case, data stored in the registers from a register having the store source top register address to a register having a register address obtained by adding the data length to the store source top register address are stored in a memory area extending from the store destination top memory address to a memory address obtained by adding the data length to the store destination top memory address.

Thirdly, the MAC determines whether the store instruction is the first store instruction or the second store instruction, generates a copy destination memory address of the copy request, which is addressed to the MACs of the copy destination processing units, and transmits the inter-unit copy request to the MACs of the copy destination processing units. The copy request includes the data to be copied and the copy destination memory address.

All the parameters of the store instruction, as described above, are able to be described in the operand of the store instruction. Alternatively, some of the parameters are able to be set in a register in the memory access controller MAC in advance, and the remaining parameters are able to be described in the operand of the store instruction. Hence, three embodiments to be described below are obtained in accordance with the parameters described in the operand and the parameters set in the register in advance.

### First Embodiment

In a first embodiment, the store instruction is described as follows.

str1_1: str [ST_S_RADD] [ST_D_MADD] [C_BT] [C_D_PU]

Here, ST_S_RADD denotes the store source register address, ST_D_MADD denotes the store destination memory address, C_BT denotes the copy bit indicating whether or not an inter-unit copy request is included, and C_D_PU denotes the copy destination processing unit information. The copy destination processing unit information is bit information having bits of the number of processing units, wherein “1” is applied to the processing units to which data are to be copied, and “0” is applied to the processing units to which data are not to be copied.

Further, when the store instruction is to store data with a certain data length, the store instruction is described as follows.

str1_2: str [ST_S_F_RADD] [DATA_LG] [ST_D_F_MADD] [C_BT] [C_D_PU]
Here, ST_S_F_RADD denotes the store source top register address, DATA_LG denotes the data length, ST_D_F_MADD denotes the store destination top memory address. The remaining parts are as described above.

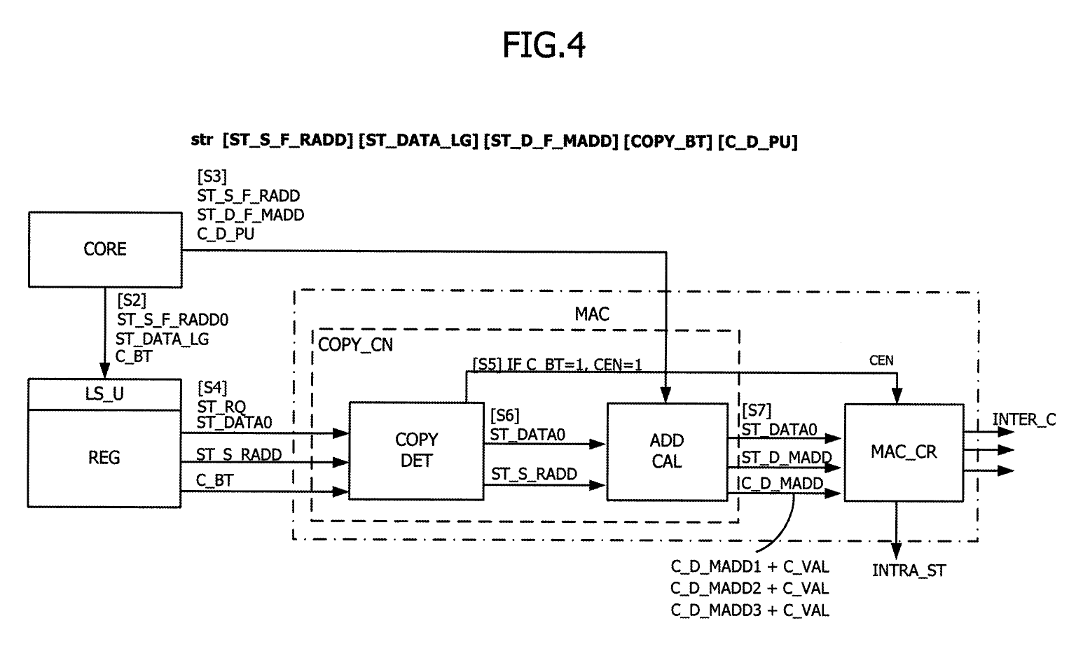

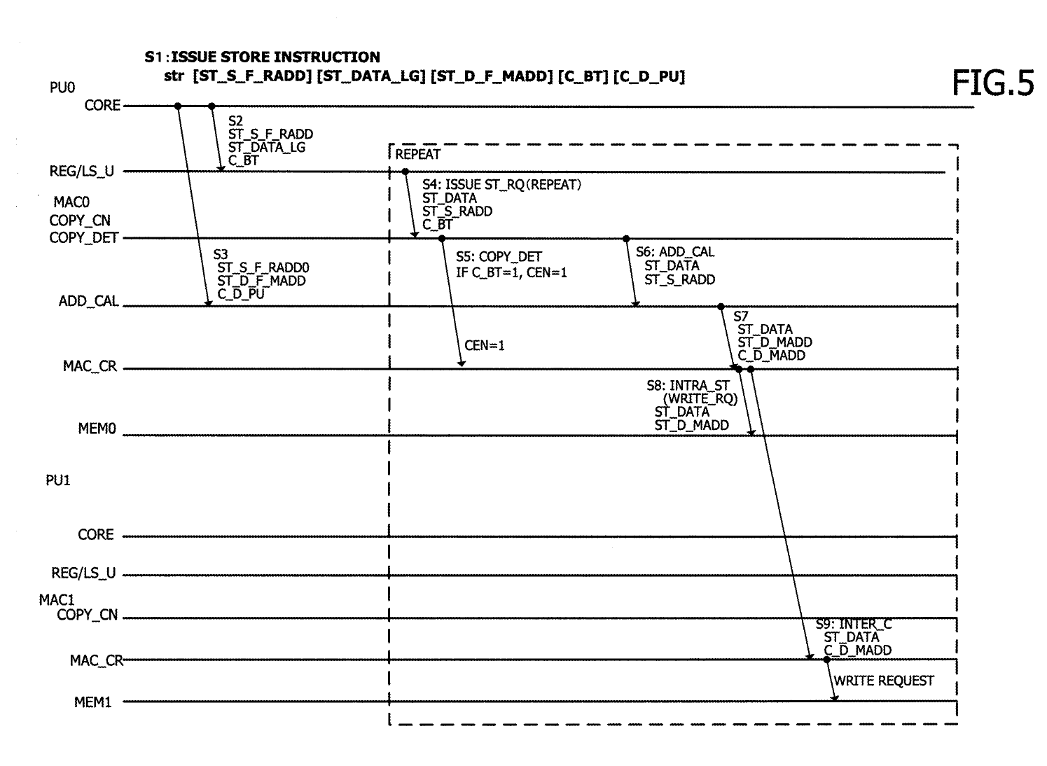

FIG. 4 is a diagram illustrating a configuration of one processing unit and data transmitted in response to a store instruction, according to the first embodiment. FIG. 5 is a diagram illustrating an operation sequence of the store instruction according to the first embodiment. The first embodiment will be described below with reference to FIGS. 4 and 5.

The processing unit illustrated in FIG. 4 includes one core CORE within a core group, a load/store unit LS_U, a register REG within the core, and a copy control circuit COPY_CN and a MAC circuit MAC_CR within a memory access controller MAC. When the core CORE executes a store instruction or a load instruction, a load/store unit LS_U provided in the register REG transmits a store request ST_RQ corresponding to the store instruction or a load request corresponding to the load instruction to the MAC. The load/store unit is provided inside the core CORE, and therefore the store request and the load request are executed by the core CORE.

The copy control circuit COPY_CN in the MAC includes a copy determination circuit COPY_DET for determining whether the store instruction is the first store instruction or the second store instruction, and an address calculation circuit ADD_CAL for generating the store destination memory address and the copy destination memory address of the store request.

In FIGS. 4 and 5, the core CORE executes the aforesaid store instruction str1_2. First, the store instruction is issued (S1). When the core CORE executes the store instruction, the core CORE outputs the store source top register address ST_S_F_RADD, the store data length ST_DATA_LG, and the copy bit C_BT to the load/store unit LS_U (S2). Further, the core CORE outputs the store source top register address ST_S_F_RADD, the store destination top memory address ST_D_F_MADD, and the copy destination processing unit information C_D_PU to the address calculation circuit ADD_CAL so that these elements are set in a register provided in the address calculation circuit (S3).

Next, the load/store unit LS_U reads the data in the store source top register address, and issues a store request ST_RQ including the store data ST_DATA, the store source register address ST_S_RADD, and the copy bit C_BT (S4). The store request ST_RQ is issued repeatedly up to a store source end register address obtained by adding the store data length to the store source top register address. Note, however, that FIG. 5 depicts only an initial store request ST_RQ and accompanying processing executed by the MAC0 and the MAC1. In actuality, the processing surrounded by a dotted line in FIG. 5 is repeated a number of times corresponding to the store data length. Thus, the store source register address ST_S_RADD is generated by adding +1 to the store source top register address ST_S_F_RADD each time, and the data in the store source register address are output as the store data ST_DATA.

In response to the store request ST_RQ, the copy determination circuit COPY_DET determines whether the copy bit C_BT indicates the first store instruction (C_BT=0) or the second store instruction (C_BT=1). When C_BT=1, the copy determination circuit COPY_DET sets a copy enable CEN at CEN=1 to enable inter-unit copying, and transmits the copy enable CEN to the MAC circuit MAC_CR (S5). When the copy enable is at CEN=1, the MAC circuit outputs an inter-unit copy request to the MAC of another processing unit.

Next, in response to the store data ST_DATA and the store source register address ST_S_RADD, transferred from the copy determination circuit, the address calculation circuit ADD CAL calculates the store destination memory address ST_D_MADD in the memory of the host processing unit and the copy destination memory address C_D_MADD in the memory of the other processing unit (S6). The address calculation circuit then outputs the store data ST_DATA, the store destination memory address ST_D_MADD, and the copy destination memory address C_D_MADD to the MAC circuit MAC_CR (S7). The copy destination memory address C_D_MADD is calculated for each copy destination processing unit.

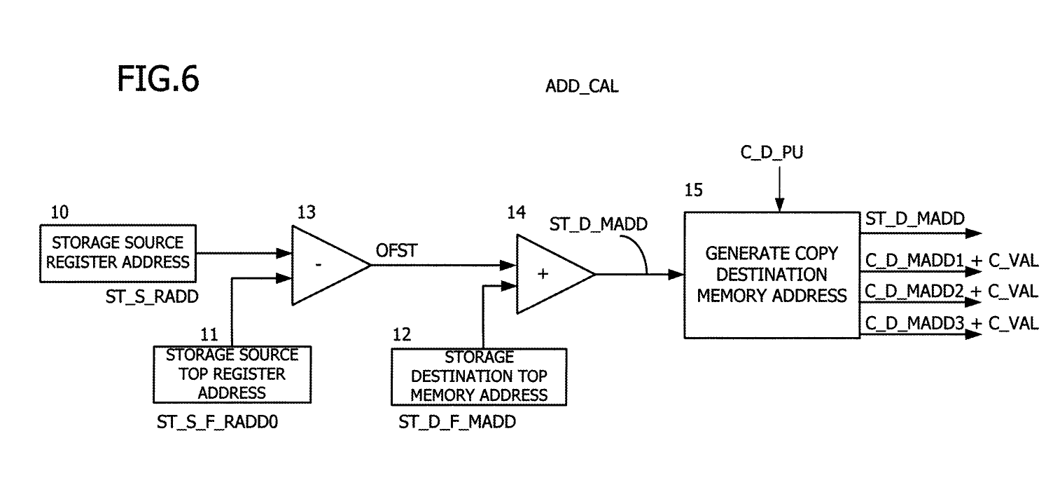

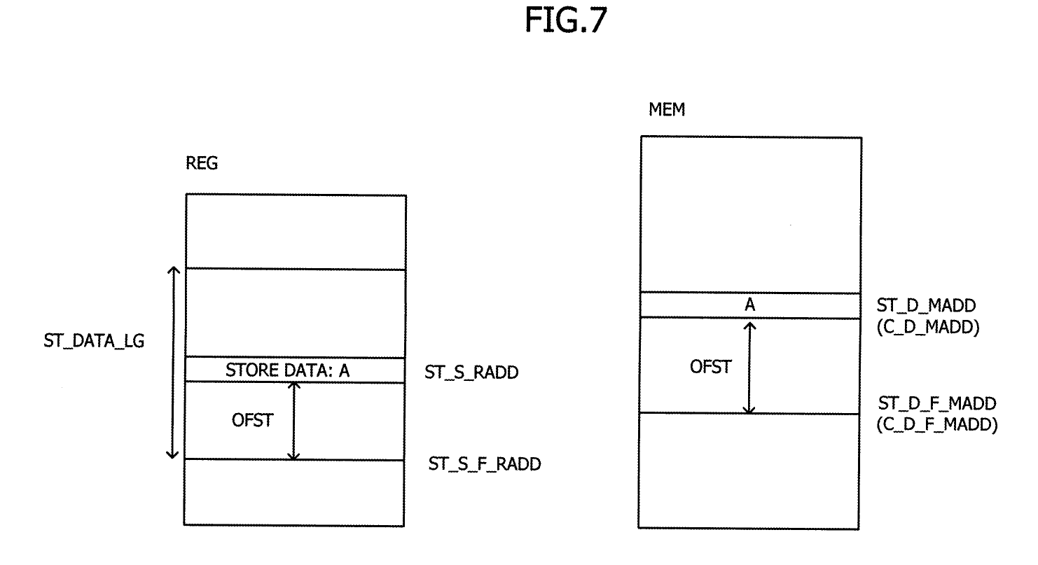

FIG. 6 is a diagram illustrating an example configuration of the address calculation circuit. FIG. 7 is a diagram illustrating the calculations performed by the address calculation circuit. The address calculation circuit sets the store source top register address ST_S_F_RADD and the store destination top memory address ST_D_F_MADD, transmitted thereto from the core CORE, in registers 11, 12, respectively. The store source register address ST_S_RADD output by the copy determination circuit COPY_DET is also input into the address calculation circuit.

FIG. 7 depicts a relationship between the store source top register address ST_S_F_RADD, the store data length ST_DATA_LG, and the store source register address ST_S_RADD in the register REG, and a relationship between the store destination top memory address ST_D_F_MADD and the store destination memory address ST_D_MADD in the memory MEM. Here, in the first embodiment, the store destination top memory address ST_D_F_MADD is identical to a copy destination top memory address C_D_F_MADD, and the store destination memory address ST_D_MADD is identical to the copy destination memory address C_D_MADD. Furthermore, the data are stored at the same copy destination memory address in the plurality of processing units serving as inter-unit copying destinations.

As illustrated by the address calculation circuit in FIG. 6, a subtractor 13 calculates an offset OFST by subtracting the store source top address from the store source register address. Further, an adder 14 calculates the store destination memory address ST_D_MADD by adding the offset OFST to the store destination top memory address ST_D_F_MADD. As noted above, the store destination memory address ST_D_MADD is identical to the copy destination memory address C_D_MADD.

Furthermore, a copy destination memory address generator 15 outputs copy destination memory addresses C_D_MADD1-3 relating to the respective processing units together with respectively corresponding copy valids C_VAL on the basis of the store destination memory address ST_D_MADD and the copy destination processing unit information C_D_PU. The copy valid C_VAL is set at C_VAL=1 (valid) with respect to the processing units serving as copy destinations, and at C_VAL=0 (invalid) with respect to the processing units not serving as copy destinations.

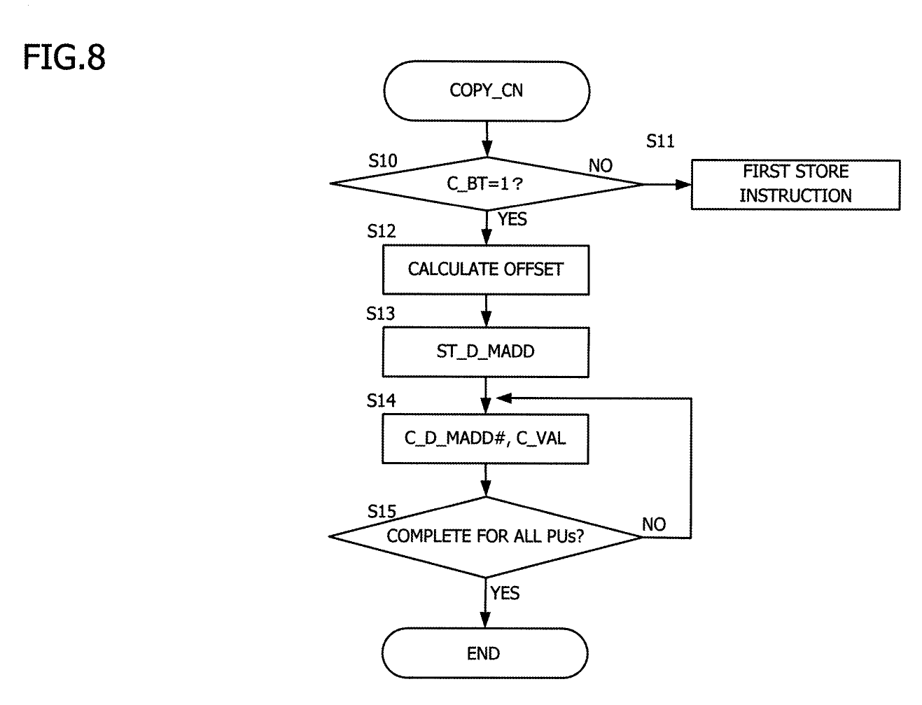

FIG. 8 is a flowchart illustrating an operation of the copy control circuit COPY_CN. The copy control circuit determines whether or not the copy bit C_BT is at “1” (S10), determines that the store instruction is the first store instruction, i.e. a normal store instruction, when the copy bit is at “0”, and determines that the store instruction is the second store instruction when the copy bit is at “1”. When the copy bit is at C_BT=1, the copy control circuit calculates an offset by subtracting the store source top register address from the store source register address (S12), calculates the store destination memory address ST_D_MADD in the memory of the host processing unit (S13), and calculates the copy destination memory address C_D_MADD in the memories of the other processing units for all of the copy destination processing units (S14, S15).

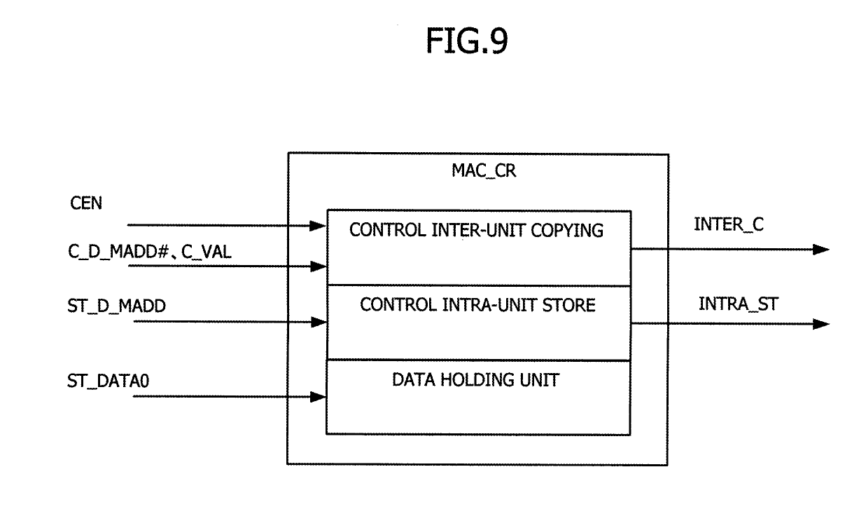

FIG. 9 is a diagram illustrating a configuration of the MAC circuit MAC_CR. Referring also to FIG. 5, the MAC circuit MAC0_CR of the MAC0 in the processing unit PU0 outputs a write request (including ST_DATA and ST_D_MADD) relating to an intra-unit store request INTRA_ST to the memory MEMO (S8). Further, when the copy enable CEN is at CEN=1, the MAC circuit MAC0_CR outputs an inter-unit copy request (ST_DATA, C_D_MADD) to the MACs of the processing units in which the copy valid C_VAL is at C_VAL=1 (S9). Even when the copy valid C_VAL is at C_VAL=1, if the copy enable CEN is at CEN=0 (copy bit C_BT=0), an inter-unit copy request is not output. In the example in FIG. 5, an inter-unit copy request is output only to the MAC1 of the processing unit PU1. The MAC1 of the processing unit PU1 then outputs a write request relating to the inter-unit copy request to the corresponding memory MEM1.

According to the first embodiment, as described above, the store instruction is one of the following two instructions.

str1_1: str [ST_S_RADD] [ST_D_MADD] [C_BT] [C_D_PU]
str1_2: str [ST_S_F_RADD] [DATA_LG] [ST_D_F_MADD] [C_BT] [C_D_PU]

The copy control circuit COPY_CN in the MAC generates the store destination memory address and the copy destination memory address from the store source register address, the store source top register address, and the store destination top memory address, and when the copy bit C_BT is at C_BT=1, the MAC circuit MAC_CR outputs a write request relating to an intra-unit store request to the memory of the host processing unit, and outputs an inter-unit copy request to the MAC of another processing unit. Thus, the core of the processing unit can store data held in the register in both the memory of the host processing unit and the memory of a different processing unit to the host processing unit (i.e. can copy the data to the other processing unit) by executing a single store instruction. Further, whether or not to request inter-unit copying can be selected using the copy bit C_BT, and the copy destination processing units can be selected as desired using the copy destination processing unit information.

### Second Embodiment

In a second embodiment, the store instruction is described as follows.

str2_1: str [ST_S_RADD] [ST_D_MADD] [C_BT]

In other words, the copy destination processing unit information C_D_PU of the store instruction str1_1 according to the first embodiment is not included.

Further, when the store instruction is to store data with a certain data length, the store instruction is described as follows.

str2_2: str [ST_S_F_RADD] [DATA_LG] [ST_D_F_MADD] [C_BT]

Likewise in this case, the copy destination processing unit information C_D_PU of the store instruction str1_2 according to the first embodiment is not included.

Note, however, that the core CORE of the processing unit PU0 sets the copy valids C_VAL1-3 of the respective processing units in the address calculation circuit of the MAC as information corresponding to the copy destination processing unit information C_D_PU before executing the store instruction. Further, the core CORE sets the copy destination top memory addresses C_D_F_MADD1-3 of the respective processing units in the address calculation circuit of the MAC. In other words, a different copy destination top memory address can be specified for each processing unit. By setting the respective copy valids correspondingly when specifying the copy destination top memory addresses, the copy destination processing unit information C_D_PU can be omitted from the parameters of the store instruction.

Meanwhile, the store instructions str2_1 and str2_2 have the store destination memory address ST_D_MADD or the store destination top memory address ST_D_F_MADD as a parameter. The reason for this is that this information indicates the store destination memory address in the memory of the host processing unit, and in the first store instruction, the store destination memory address is normally included as a parameter.

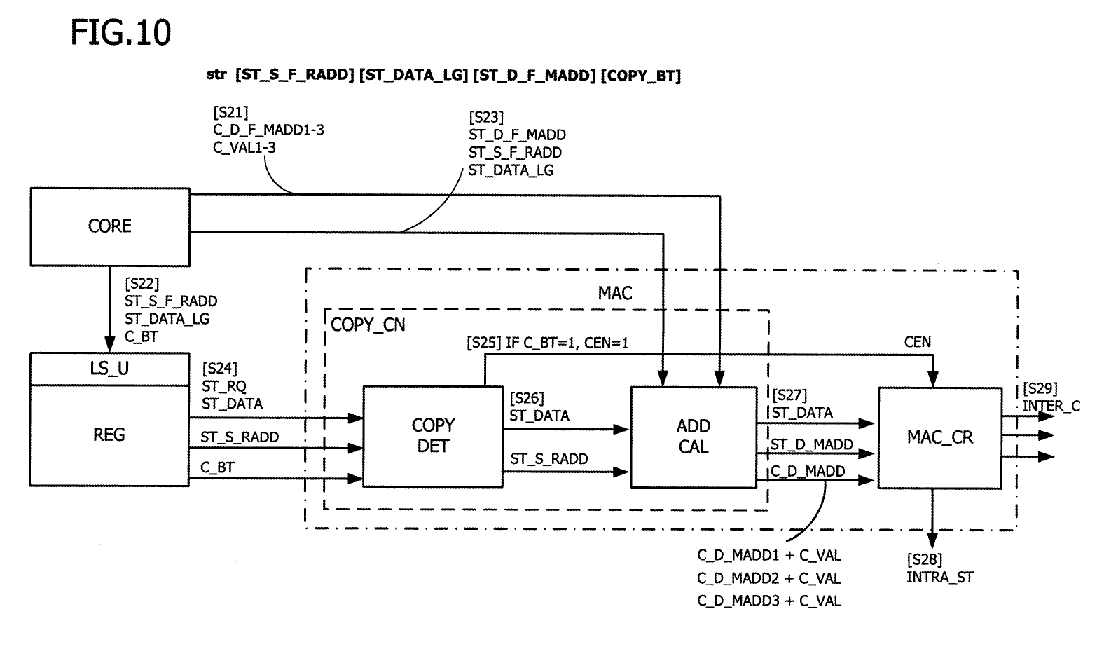

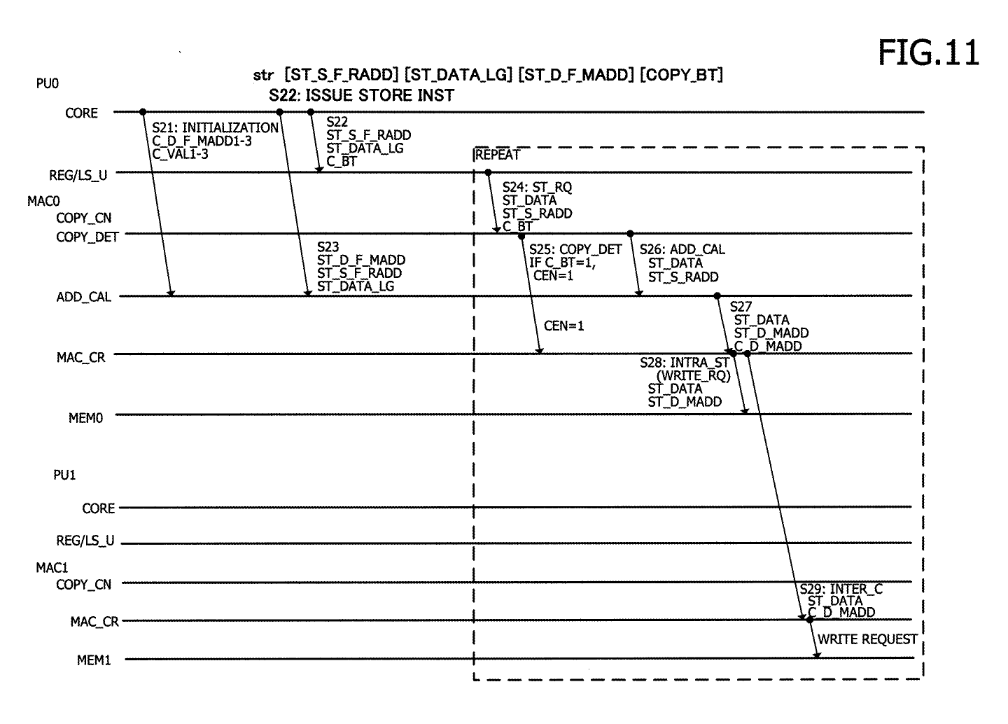

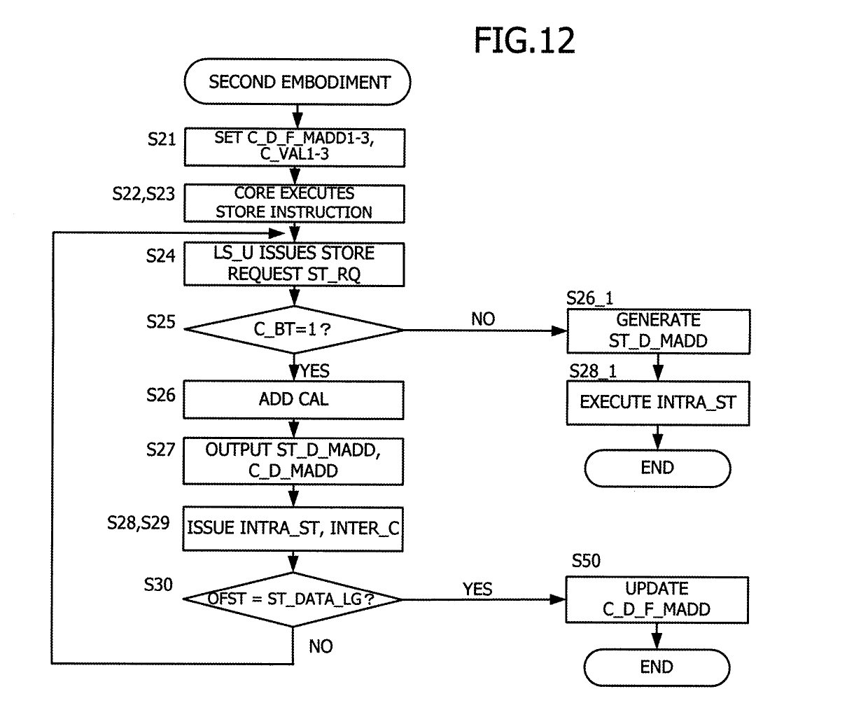

FIG. 10 is a diagram illustrating a configuration of one processing unit and data transmitted in response to a store instruction, according to the second embodiment. FIG. 11 is a diagram illustrating an operation sequence of the store instruction according to the second embodiment. Further, FIG. 12 is a flowchart illustrating operations relating to the store instruction, according to the second embodiment.

Similarly to FIG. 4, the processing unit illustrated in FIG. 10 includes one core CORE within a core group, a register REG, and a copy control circuit COPY_CN and a MAC circuit MAC_CR within a memory access controller MAC. Further, a load/store unit LS_U is provided in the register REG.

The copy control circuit COPY_CN in the MAC includes a copy determination circuit COPY_DET for determining whether the store instruction is the first store instruction or the second store instruction, and an address calculation circuit ADD_CAL for generating the store destination memory address and the copy destination memory address C_D_MADD of the store request.

In the second embodiment, the address calculation circuit ADD_CAL differs from that of the first embodiment. In the second embodiment, the copy valids C_VAL1-3 and the copy destination top memory addresses C_D_F_MADD1-3 are set in the address calculation circuit by the core before the core executes the store instruction. As a result, the core can specify a desired processing unit as a copy destination processing unit, and specify identical or different copy destination top memory addresses for a plurality of copy destination processing units.

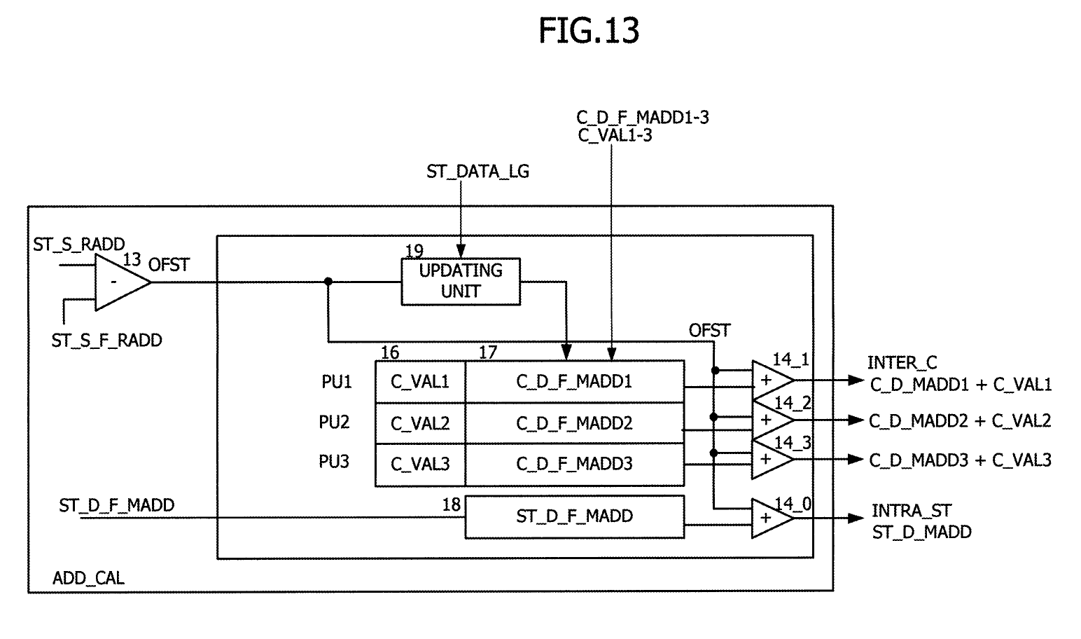

FIG. 13 is a diagram illustrating an example configuration of the address calculation circuit. The address calculation circuit ADD CAL includes a subtractor 13 for determining the offset OFST by subtracting the store source top register address ST_S_F_RADD from the store source register address ST_S_RADD, a register 16 for setting the copy valids C_VAL1-3 for the respective processing units, a register 17 for setting the copy destination top memory addresses C_D_F_MADD1-3 for the respective processing units, and a register 18 for holding the store destination top memory address ST_D_F_MADD. Furthermore, the address calculation circuit includes adders 14_1-14_3 for adding the offset OFST to the respective copy destination top memory addresses C_D_F_MADD1-3 and outputting copy destination memory addresses C_D_{—} MADD1-3, and an adder 14_0 for adding the offset OFST to the store destination top memory address ST_D_F_MADD and outputting the store destination memory address ST_D_MADD.

The address calculation circuit also includes an updating unit 19. When the offset OFST becomes equal to the store data length ST_DATA_LG, the updating unit 19 updates the copy destination top memory addresses C_D_F_MADD1-3 and the store destination top memory address ST_D_F_MADD to values obtained by adding the store data length ST_DATA_LG respectively thereto. When a subsequent second store instruction is executed after updating the copy destination top memory addresses and the store destination top memory address, it is prevented that new store data are overwritten to the copy destination memory addresses and the store destination memory address used during execution of the initial or previous second store instruction.

In the second embodiment, instead of including store destination unit information in the operand of the store instruction, the copy valids C_VAL1-3, which are equivalent to store destination unit information, are set in the copy control circuit in advance, before executing the store instruction. Further, the copy destination top memory addresses C_D_F_MADD1-3, which are different or identical for each copy destination processing unit, are set in the copy control circuit in advance, before executing the store instruction. In all other respects, the second embodiment is similar to the first embodiment.

An operation of the processing unit PU0 according to the second embodiment will be described below with reference to FIGS. 10, 11, and 12. Likewise here, the store instruction str2_2 will be used as an example.

As preparation or initialization for executing the store instruction, the core CORE sets the respective copy valids C_VAL1-3 and copy destination top memory addresses C_D_F_MADD of the other processing units in the address calculation circuit ADD_CAL of the copy control circuit COPY_CN (S21).

Next, the core CORE executes the store instruction str2_2. First, the store instruction is issued. When the core CORE executes the store instruction, the core CORE outputs the store source top register address ST_S_F_RADD, the store data length ST_DATA_LG, and the copy bit C_BT to the load/store unit LS_U (S22). This processing is identical to S2 of the first embodiment. Further, the core CORE transmits the store source top register address ST_S_F_RADD, the store destination top memory address ST_D_F_MADD, and the store data length ST_DATA_LG to the address calculation circuit ADD_CAL so that these elements are set in the registers provided in the address calculation circuit (S23).

Next, the load/store unit LS_U executes S24 that is the same as S4 of the first embodiment. More specifically, the load/store unit reads the data in the store source top register address, and issues a store request ST_RQ including the store data ST_DATA, the store source register address ST_S_RADD, and the copy bit C_BT (S24). The store request ST_RQ is issued repeatedly from the store source top register address to the store source end register address obtained by adding the store data length to the store source top register address. In other words, in FIG. 11, the processing surrounded by a dotted line is repeated a number of times corresponding to the store data length. This is similar to S4 of the first embodiment.

In response to the store request ST_RQ, the copy determination circuit COPY_DET executes S25 that is the same as S5. More specifically, the copy determination circuit determines whether the copy bit C_BT indicates the first store instruction (C_BT=0) or the second store instruction (C_BT=1). When C_BT=1, the copy determination circuit sets the copy enable CEN at CEN=1 and transmits the copy enable to the MAC circuit MAC_CR (S25). When the copy enable is at CEN=1, the MAC circuit outputs an inter-unit copy request to the MAC of the other processing unit.

Next, in response to the store data ST_DATA and the store source register address ST_S_RADD, transferred from the copy determination circuit, the address calculation circuit ADD CAL calculates the store destination memory address ST_D_MADD in the memory of the host processing unit and the copy destination memory address C_D_MADD in the memory of the other processing unit (S26). The address calculation circuit then outputs the store data ST_DATA, the store destination memory address ST_D_MADD, and the copy destination memory address C_D_MADD to the MAC circuit (S27). The address calculation circuit depicted in FIG. 13 generates the store destination memory address ST_D_MADD and the copy destination memory address

C_D_MADD on the basis of the copy destination top memory address set in advance, the store destination top memory address input during execution of the store instruction, and the store source register address ST_S_RADD input from the copy determination circuit.

Thereafter, the processing is identical to S8 and S9 of the first embodiment. More specifically, the MAC circuit MAC0_CR of the MAC0 in the processing unit PU0 outputs a write request WRITE_RQ (including ST_DATA and ST_D_MADD) relating to the intra-unit store request INTRA_ST to the memory MEMO (S28). Further, when the copy enable CEN is at CEN=1, the MAC circuit MAC0_CR outputs an inter-unit copy request INTER_C (ST_DATA, C_D_MADD) to the MACs of the processing units in which the copy valid C_VAL is at C_VAL=1 (S29). In the example of FIG. 11, an inter-unit copy request INTER_C is output only to the MAC1 of the processing unit PU1 (S29). The MAC1 of the processing unit PU1 then outputs a write request relating to the inter-unit copy request to the corresponding memory MEM1.

In contrast to the first embodiment, once the load/store unit has issued the store request ST_RQ repeatedly the number of times corresponding to the store data length, the updating unit 19 of the address calculation circuit detects that the offset OFST is equal to the store data length ST_DATA_LG (YES in S30), and updates the copy destination top memory addresses C_D_F_MADD1-3 in the register 17 to addresses respectively obtained by adding the store data length thereto (S50). As a result, it is prevented that different store data are overwritten to the same copy destination memory addresses in response to a subsequent store instruction.

The flowchart of FIG. 12 depicts processing executed when the copy bit C_BT is not at “1”, and therefore the address calculation circuit generates the store destination memory address ST_D_MADD and outputs an intra-unit store request to the MAC (S26_1), whereupon the MAC executes writing corresponding to the intra-unit store request INTRA_ST to the memory of the host processing unit (S28_1).

According to the second embodiment, a different copy destination memory area can be set in advance for each copy destination processing unit. Further, the copy bit specifying the copy destination processing units is set in advance, and therefore the copy destination processing unit information can be omitted from the parameters of the store instruction.

### Third Embodiment

In a third embodiment, the store instruction is described as follows.

str3_1: str [ST_S_RADD] [ST_D_MADD]
In other words, the copy bit C_BT of the store instruction str2_1 according to the second embodiment is not included.

Further, when the store instruction is to store data with a certain data length, the store instruction is described as follows.

str3_2: str [ST_S_F_RADD] [DATA_LG] [ST_D_F_MADD]
Likewise in this case, the copy bit C_BT of the store instruction str2_2 according to the second embodiment is not included.

Note, however, that the core CORE of the processing unit PU0 sets the copy bit C_BT as well as a copy subject top register address F_RADD and a copy subject end register address E_RADD denoting a copy subject register address area in the copy determination circuit COPY_DET before executing the store instruction.

Further, similarly to the second embodiment, the core CORE sets the copy valids C_VAL1-3 of the respective processing units in the address calculation circuit of the MAC as information corresponding to the copy destination processing unit information C_D_PU before executing the store instruction. Furthermore, the core CORE sets the copy destination top memory addresses C_D_F_MADD1-3 of the respective processing units in the address calculation circuit of the MAC.

Meanwhile, the store instructions str3_1 and str3_2 have the store destination memory address ST_D_MADD or the store destination top memory address ST_D_F_MADD as a parameter. The reason for this is that this information indicates the store destination memory address in the memory of the host processing unit, and in the first store instruction, the store destination memory address is normally included as a parameter.

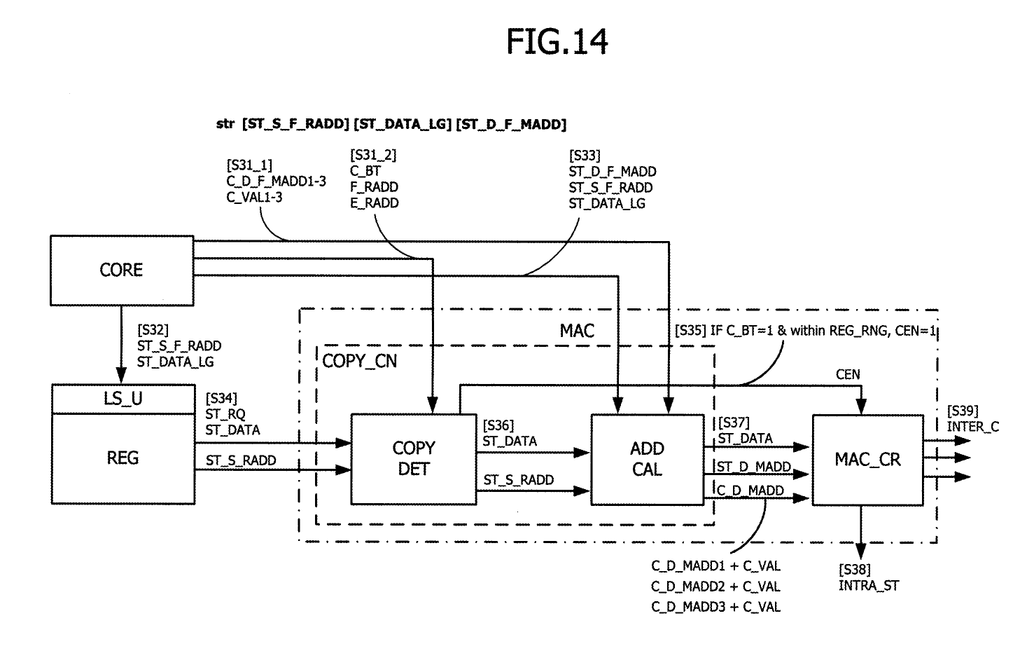

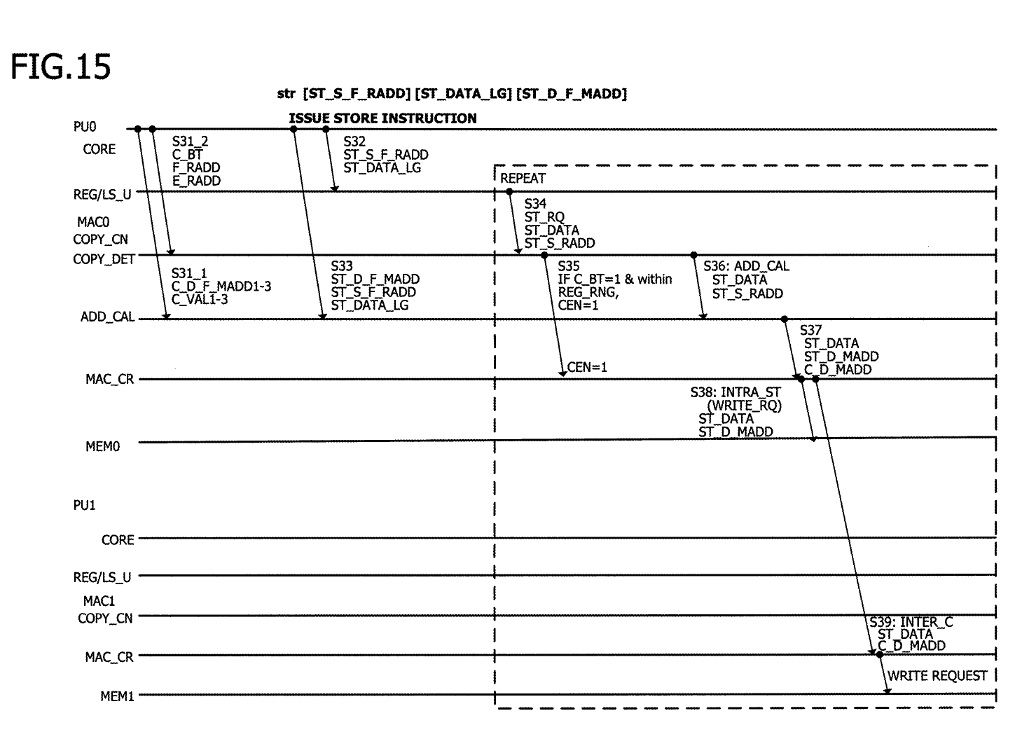

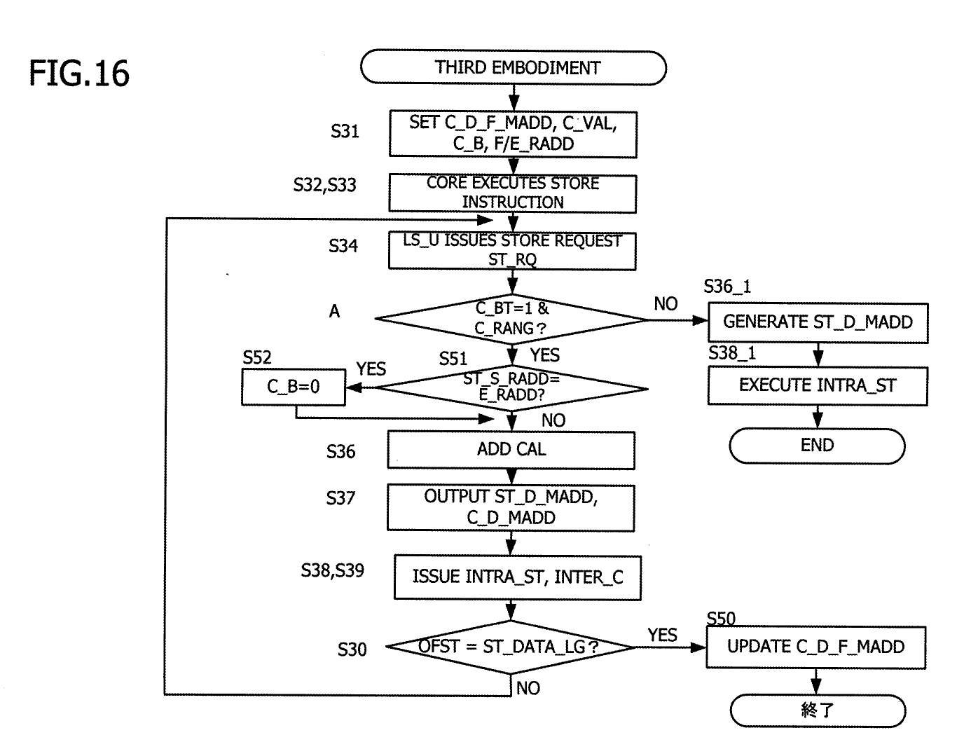

FIG. 14 is a diagram illustrating a configuration of one processing unit and data transmitted in response to a store instruction, according to the third embodiment. FIG. 15 is a diagram illustrating an operation sequence of the store instruction according to the third embodiment. Further, FIG. 16 is a flowchart illustrating operations performed in response to the store instruction, according to the third embodiment.

The processing unit illustrated in FIG. 14 is identical to that of the second embodiment, illustrated in FIG. 10, apart from one exception. The configuration in FIG. 14 that differs from FIG. 10 is the copy determination circuit COPY_DET. The address calculation circuit ADD_CAL and the MAC circuit MAC_CR are identical to their counterparts in FIG. 10.

In the third embodiment, as noted above, the copy bit C_BT as well as the top register address F_RADD and end register address E_RADD denoting to store and copy subject register address areas are set in the copy determination circuit COPY_DET before executing the store instruction. Moreover, similarly to the second embodiment, the core sets the copy valids C_VAL1-3 and the copy destination top memory addresses C_D_F_MADD1-3 in the address calculation circuit before executing the store instruction.

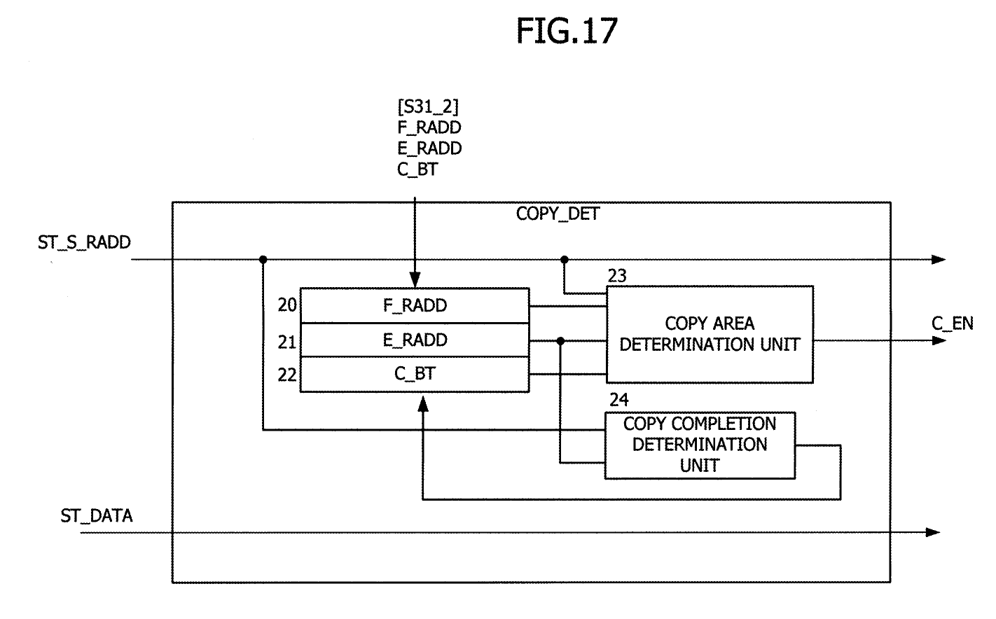

FIG. 17 is a diagram illustrating an example configuration of the copy determination circuit. The copy determination circuit COPY_DET includes registers 20, 21, 22 in which the copy subject top register address F_RADD, the copy subject end register address E_RADD, and the copy bit C_BT are respectively set. When the copy bit C_BT is at “1” and the store source register address ST_S_RADD is within a range extending from the top register address F_RADD to the end register address E_RADD, a copy area determination unit 23 sets the copy enable CEN at “1” and outputs the copy enable C_EN to the MAC circuit. Thus, the core can set subsequent store instructions as the second store instruction (a store instruction including inter-unit copying) and set a copy subject register address range in advance. As a result, the copy bit can be omitted from the parameters of the store instruction.

Further, when the store source register address ST_S_RADD matches the end register address E_RADD, a copy completion determination unit 24 modifies the copy bit C_BT in the register 22 to “0”. As a result, it is prevented that different store data are overwritten to a memory address in which data have already been stored in response to a subsequent second store instruction is prevented from occurring.

An operation of the processing unit PU0 according to the third embodiment will be described below with reference to FIGS. 14, 15, and 16. Likewise here, the store instruction str3_2 will be used as an example.

As preparation or initialization for executing the store instruction, the core CORE sets the respective copy valids C_VAL1-3 and copy destination top memory addresses C_D_F_MADD of the other processing units in the address calculation circuit ADD_CAL of the copy control circuit COPY_CN (S31_1). This processing is identical to that of S21 according to the second embodiment. Further, as preparation or initialization, the core CORE sets the copy subject top register address F_RADD, the copy subject end register address E_RADD, and the copy bit C_BT in the copy determination circuit COPY_DET (S31_2). This setting is not executed in the second embodiment.

Next, the core CORE executes the store instruction str3_2. First, the store instruction is issued. When the core CORE executes the store instruction, the core CORE outputs the store source top register address ST_S_F_RADD and the store data length ST_DATA_LG to the load/store unit LS_U (S32). This processing S32 differs from S22 in the second embodiment in that the copy bit C_BT is not included. Further, the core CORE transmits the store source top register address ST_S_F_RADD, the store destination top memory address ST_D_F_MADD, and the store data length ST_DATA_LG to the address calculation circuit ADD_CAL so that these elements are set in the registers of the address calculation circuit (S33). This processing is identical to S23 according to the second embodiment.

Next, the load/store unit LS_U reads the data in the store source top register address, and issues a store request ST_RQ including the store data ST_DATA and the store source register address ST_S_RADD (S34). This processing S34 differs from S24 in the second embodiment in that the copy bit C_BT is not included. The store request ST_RQ is issued repeatedly from the store source top register address to the store source end register address obtained by adding the store data length to the store source top register address. This point is identical to the second embodiment.

In response to the store request ST_RQ, the copy area determination unit 23 of the copy determination circuit determines whether or not the copy bit C_BT indicates the second store instruction (C_BT=1) and the store source register address ST_S_RADD is within a range REG_RNG extending from the top register address F_RADD to the end register address E_RADD. When the determination is affirmative, the copy area determination unit 23 sets the copy enable CEN at CEN=1, and outputs the copy enable CEN to the MAC circuit MAC_CR (S35). This processing S35 differs from the processing S25 of the second embodiment. When the copy enable CEN is at CEN=1, the MAC circuit outputs an inter-unit copy request INTER_C to the MAC of the other processing unit.

Next, similarly to the processing S26 and S27 of the second embodiment, the address calculation circuit ADD_CAL calculates the store destination memory address ST_D_MADD in the memory of the host processing unit and the copy destination memory address C_D_MADD in the memory of the other processing unit (S36), and then outputs the store data ST_DATA, the store destination memory address ST_D_MADD, and the copy destination memory address C_D_MADD to the MAC circuit (S37).

Thereafter, similarly to S8 and S9 of the first embodiment and S28 and S29 of the second embodiment, the MAC circuit MAC0_CR of the MAC0 in the processing unit PU0 outputs a write request (including ST_DATA and ST_D_MADD) relating to the intra-unit store request INTRA_ST to the memory MEMO (S38). Further, when the copy enable CEN is at CEN=1, the MAC circuit MAC0_CR outputs an inter-unit copy request (ST_DATA, C_D_MADD) to the MAC of the processing unit in which the copy valid C_VAL is at C_VAL=1 (S39). The MAC1 of the processing unit PU1 then outputs a write request relating to the inter-unit copy request to the corresponding memory MEM1.

Similarly to the second embodiment, once the load/store unit has issued the store request ST_RQ repeatedly the number of times corresponding to the store data length, the updating unit 19 of the address calculation circuit detects that the offset OFST is equal to the store data length ST_DATA_LG (YES in S30), and updates the copy destination top memory addresses C_D_F_MADD1-3 in the register 17 to addresses respectively obtained by adding the store data length thereto (S50).

Further, in the third embodiment, when the store source register address ST_S_RADD matches the end register address E_RADD (YES in S51), the copy completion determination unit 24 of the copy determination circuit COPY_DET modifies the copy bit C_BT in the register 22 to “0” (S52), thereby prohibiting the execution of subsequent second store instructions.

The flowchart of FIG. 16 likewise depicts processing executed when the copy bit C_BT is not at “1”, and therefore the address calculation circuit generates the store destination memory address ST_D_MADD and outputs an intra-unit store request to the MAC (S36_1), whereupon the MAC executes writing corresponding to the intra-unit store request INTRA_ST to the memory of the host processing unit (S38_1).

According to the third embodiment, as described above, the store instruction can be set as the second store instruction (including inter-unit copying) in advance using the copy bit C_BT. Moreover, the register address range that is to serve as the subject of the second store instruction can be set in advance by the top register address F_RADD and the end register address E_RADD.

It is assumed that the register address area extending from the copy subject top register address F_RADD to the copy subject end register address E_RADD will be larger than the register address area defined by the store source top register address and the store data length ST_DATA_LG, specified by the parameters of the store instruction. Normally, the data in the register address area extending from the top register address F_RADD to the end register address E_RADD are stored in-unit and copied between units by executing the second store instruction a plurality of times. The data in the register address area extending from the copy subject top register address F_RADD to the copy subject end register address E_RADD are stored in-unit and copied between units by executing the second store instruction (store and copy ST&C) a plurality of times through processing 1 illustrated in FIG. 3.

### Fourth Embodiment

A fourth embodiment includes the same copy determination circuit as the third embodiment and the same address calculation circuit as the first embodiment. Accordingly, the core sets the copy bit, the copy subject top register address F_RADD, and the copy subject end register address E_RADD in the copy determination circuit before executing the store instruction. Further, in response to a copy request from the core, the copy determination circuit outputs the copy enable CEN=1, indicating that inter-unit copying is to be executed, when the copy bit requests inter-unit copying and the store source register address included in the copy request is within a range extending from the copy subject top register address F_RADD to the copy subject end register address E_RADD.

In the fourth embodiment, the store instruction is described as follows.

str4_1: str [ST_S_RADD] [ST_D_MADD] [C_D_PU]
In other words, the copy bit C_BT of the store instruction str1_1 according to the first embodiment is not included.

Further, when the store instruction is to store data with a certain data length, the store instruction is described as follows.

str4_2: str [ST_S_F_RADD] [DATA_LG] [ST_D_F_MADD] [C_D_PU]
Likewise in this case, the copy bit C_BT of the store instruction str1_2 according to the first embodiment is not included.

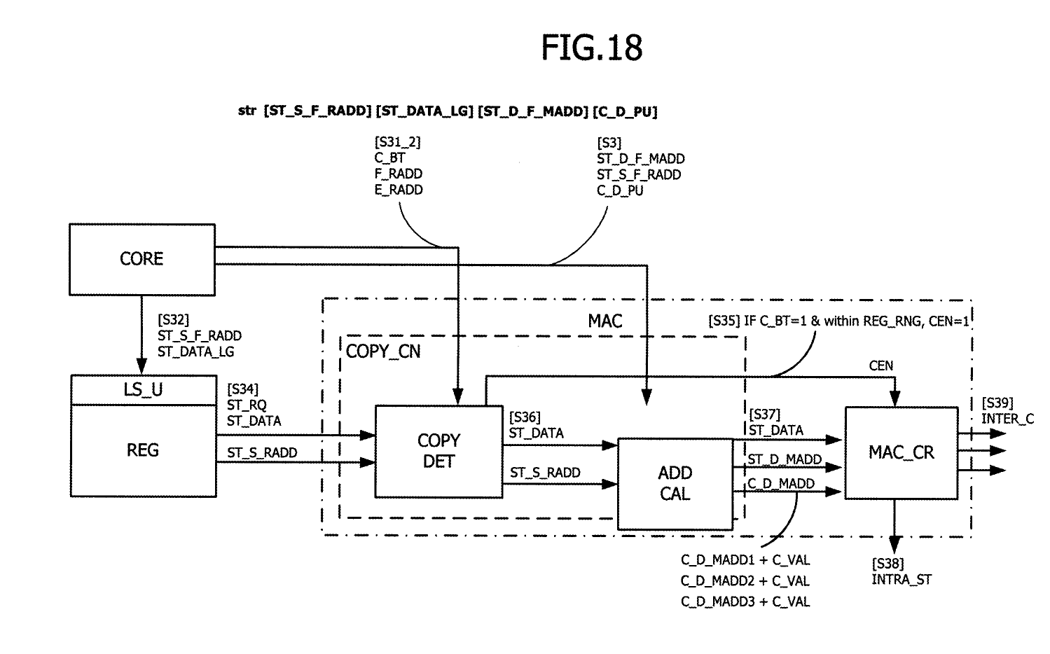

FIG. 18 is a diagram illustrating a configuration and an operation of a certain processing unit according to the fourth embodiment. The operation illustrated in FIG. 18 will be described in comparison with FIG. 14 of the third embodiment. First, the core executes the processing S31_2 as advance setting, but does not execute the processing S31_1 of FIG. 14. Then, to execute the store instruction str4_2, the core executes the processing S32 and the processing S3 (same as S3 in FIG. 4), whereupon the load/store unit outputs the store request ST_RQ in the processing S34. In response to the store request, the core determination circuit executes the processing S35, whereupon the address calculation circuit executes the processing S36 and S37 and the MAC circuit MAC_CR executes the processing S38 and S39.

In the fourth embodiment, the copy bit is omitted from the parameters of the store instruction and set in advance instead.

According to this embodiment, as described above, the core can store data held in the register in the memory of the host processing unit and copy the same data to the memory of another processing unit at the same time by executing a single store instruction.

In the embodiment described above, all four of the processing units PU0-PU3 are provided with the copy control circuit COPY_CN so as to be capable of executing the second store instruction, but the copy control circuit COPY_CN does not necessarily have to be provided in all of the processing units, and is be able to be provided in at least one of the processing units so that the core of that processing unit can execute the second store instruction.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing device comprising:
a plurality of processing units, each having
a core that executes arithmetic processing,
a memory, and
a memory access controller (a MAC hereafter) that controls access to the memory in response to an access request issued by the core, wherein
the core of a first processing unit among the plurality of processing units executes a store instruction to issue a store request for the store instruction, and
the MAC of at least the first processing unit: in response to the store request issued by the core of the first processing unit, when the store request requests an inter-unit copy, which stores data of the store request to the memory of a second processing unit different from the first processing unit,
issues a write request of an intra-unit store, which stores the data of the store request to the memory of the first processing unit, to the memory of the first processing unit, and
transmits a request of the inter-unit copy to the MAC of the second processing unit.

2. The arithmetic processing device according to claim 1, wherein
the core includes:
an arithmetic unit and
a result register that stores arithmetic processing results obtained by the arithmetic unit, and
the core of the first processing unit:
executes the store instruction including a store source top register address, a store data length, a store destination top memory address, a copy bit indicating whether or not the inter-unit copy is requested, and copy destination processing unit information; and
issues the store request the number of times corresponding to the store data length.

3. The arithmetic processing device according to claim 2, wherein
the MAC of the first processing unit:
includes an address calculation circuit that generates a store destination memory address in the memory of the first processing unit and a copy destination memory address in the memory of the second processing unit in response to the store request issued by the core of the first processing unit;
issues the write request including the store destination memory address and store data to the memory of the first processing unit; and
when the copy bit requests the inter-unit copy, includes, in the request of the inter-unit copy, the copy destination memory address and the store data, and transmits the request of the inter-unit copy to the MAC of the second processing unit.

4. The arithmetic processing device according to claim 3, wherein
the core outputs the store source top register address, the store destination top memory address, and the copy destination processing unit information to the address calculation circuit,
the store request issued by the core in the first processing unit includes a store source register address and the copy bit, and
the address calculation circuit of the MAC of the first processing unit:
generates the store destination memory address by adding an offset value between the store source top register address and the store source register address to the store destination top memory address; and
generates the copy destination memory address on the basis of the copy destination processing unit information, the store source register address, and the offset value.

5. The arithmetic processing device according to claim 2, wherein
the MAC of the first processing unit determines whether or not the request of the inter-unit copy is to be to transmitted on the basis of the copy bit.

6. The arithmetic processing device according to claim 1, wherein
the core includes:
an arithmetic unit and
a result register that stores arithmetic processing results obtained by the arithmetic unit, and
the core of the first processing unit:
sets in the MAC of the first processing unit a copy valid corresponding to a copy destination processing unit and a copy destination top memory address in the memory of the copy destination processing unit;
after the setting, executes the store instruction including a store source top register address, a store data length, a store destination top memory address, and a copy bit indicating whether or not the inter-unit copy is requested; and
issues the store request the number of times corresponding to the store data length.

7. The arithmetic processing device according to claim 6, wherein
the MAC of the first processing unit:
includes an address calculation circuit which generates a store destination memory address in the memory of the first processing unit and a copy destination memory address in the memory of the second processing unit, in response to the store request issued by the core;
issues the write request including the store destination memory address and store data to the memory of the first processing unit; and
when the copy bit requests the inter-unit copy, includes, in the request of the inter-unit copy, the copy destination memory address and the store data, and transmits the request of the inter-unit copy to the MAC of the second processing unit.

8. The arithmetic processing device according to claim 7, wherein
the core of the first processing unit sets in the MAC of the first processing unit a different copy destination top memory address for each of the plurality of copy destination processing units.

9. The arithmetic processing device according to claim 1, wherein
the core includes:
an arithmetic unit; and
a result register that stores arithmetic processing results obtained by the arithmetic unit, and
the core of the first processing unit:
sets, in the MAC of the first processing unit, a copy valid corresponding to a copy destination processing unit, a copy destination top memory address indicating a top memory address of the copy destination processing unit, a copy subject top register address, a copy subject end register address, and a copy bit indicating whether or not the inter-unit copy is requested; and
after the setting, executes the store instruction including a store source top register address, a store data length, and a store destination top memory address, and issues the store request the number of times corresponding to the store data length.

10. The arithmetic processing device according to claim 9, wherein
the MAC of the first processing unit:
makes a copy enable valid for enabling the inter-unit copy when a store source register address of the store request is within a range of register address which extends from the copy subject top register address to the copy subject end register address and the copy bit requests the inter-unit copy;
includes an address calculation circuit which, in response to the store request issued by the core, generates a store destination memory address in the memory of the first processing unit and a copy destination memory address in the memory of the second processing unit;
issues the write request including the store destination memory address and store data to the memory of the first processing unit; and
when the copy enable is valid, includes the copy destination memory address and the store data in the request of the inter-unit copy, and transmits the request of the inter-unit copy to the MAC of the second processing unit.

11. The arithmetic processing device according to claim 1, wherein the core includes:
an arithmetic unit; and
a result register that stores arithmetic processing results obtained by the arithmetic unit, and
the core of the first processing unit:
sets, in the MAC of the first processing unit, a copy subject top register address, a copy subject end register address, and a copy bit indicating whether or not the inter-unit copy is requested; and
after the setting, executes the store instruction including a store source top register address, a store data length, a store destination top memory address, and copy destination processing unit information, and issues the store request the number of times corresponding to the store data length.

12. A method of controlling an arithmetic processing device, the method comprising:
executing, by a core of a first processing unit among a plurality of processing units, a store instruction to issue a store request for the store instruction, wherein the plurality of processing units each has a core that executes arithmetic processing, a memory, and a memory access controller (a MAC hereafter) that controls access to the memory in response to an access request issued by the core; and
by the MAC of at least a first processing unit among the plurality of processing units, in response to the store request issued by the core of the first processing unit, when the store request requests an inter-unit copy, which stores data of the store request to the memory of a second processing unit different from the first processing unit,
issuing a write request of an intra-unit store, which stores the data of the store request to the memory of the first processing unit, to the memory of the first processing unit, and
transmitting a request of the inter-unit copy to the MAC of the second processing unit.
